(19) United States
(12) Patent Application Publication
(10) Pub. No.: US 2022/0289089 A1
(43) Pub. Date: Sep. 15, 2022

(54) PORTABLE ASSEMBLY FOR SUPPORT PLATFORM AND GAME PLATFORM

(71) Applicant: EAST PARK, LLC, Greenville, SC (US)

(72) Inventors: Robert Morgan, Greenville, SC (US); Todd Paquin, Easley, SC (US)

(73) Assignee: EAST PARK, LLC, Greenville, SC (US)

(21) Appl. No.: 17/694,037

(22) Filed: Mar. 14, 2022

Related U.S. Application Data
(60) Provisional application No. 63/160,862, filed on Mar. 14, 2021.

(51) Int. Cl. B60N 3/00; A63B 67/06

(52) U.S. Cl. CPC B60N 3/001; A63B 67/06; A63B 2210/50

(57) ABSTRACT

A portable convertible platform assembly comprising of a first configuration having a horizontal support surface including a first and a second section in a locked position; second configuration wherein the sections are placed in a folded arrangement; and, third configuration wherein the support surface has an opening for receiving a game bag. The first configuration can include a rear support strap for securing the platform to the hood of a vehicle, a rear leg, and a front leg. The front leg can include an adjustable height. The third configuration can include an opening cover configured to be received in the opening.

### RELATED APPLICATIONS

This Application claims priority to U.S. Provisional Patent Application 62/653,924 filed Apr. 08, 2018.

### BACKGROUND OF THE INVENTION

### 1) Field of the Invention

This assembly is directed to a portable convertible support surface and game platform for use with a vehicle that can be used at social events.

### 2) Description of the Related Art

This assembly is directed to a portable combination support surface and game that can be used for social events. It has become increasingly popular to participate in “tailgating”, especially in connection with sporting events. “Tailgating” gets its name as some of the social events associated with tailgating are held on and around the open tailgate of a vehicle. The tailgate can be used as a support surface for food, drinks and other articles providing a table of sorts for the participants. Tailgating, which primarily takes place in the United States, can involve consuming alcoholic beverages, grilling food and playing games making the existence of a support surface convenient for the participants. Tailgating can occur in the parking lots at event venues, before and occasionally after the event.

The popularity of tailgating has resulted in participants having “tailgating” events, even if their vehicles do not have tailgates. Tailgating is often seen as a critical part of the sports experience and because many sports venues are surrounded by large parking lots, tailgating often takes place right outside the event venue. Tailgate parties have spread to the pre-game festivities at most sporting events including football, basketball, hockey, baseball, and can include non-sporting events such as weddings, barbecues, and concerts. Due to the nature of tailgating, having a support surface that can be moved from location to location is important as the location of events, venues, games, and the like move from location to location. Further, tailgating can also be associated with camping, picnics, celebrations, holidays, promotional events, parking lot parties, day trips and the like. It would be advantageous to have a support surface that can be used with a vehicle. United States Patent Application Publication 2005/0241546 discloses an umbrella and table support including telescopic tubes projecting rearwardly from a trailer hitch receiver.

Several attempts have been made to provide for a mobile support surface including U.S. Pat. No. 6,739,269 which discloses a portable tailgate table having one end adapted to be supported by a receiver of a hitch assembly of an automotive vehicle and a second end supported by at least one leg. U.S. Pat. No. 6,467,417 discloses foldable table for a vehicle and provides a durable work surface suited for construction work and the like but is affixed to the vehicle. U.S. Pat. No. 5,219,106 discloses a carrier mountable to an off-road-type vehicle for transporting harvested game that has a game supporting platform with tubular framing. It also has a substantially planar platform surface and is adapted to overlie the hood of the vehicle. It has a bracket for attaching the platform over the hood of the vehicle.

Additionally, toss games have been popular at such events such as the game referred to as “corn hole.” While toss games, including bag toss games, have been known for quite some time, games involving tossing a ball or bag into an opening in an angled platform have recently gained popularity at tailgating events. U.S. Pat. No. 285,396 issued in 1883, describes an inclined board with a square opening where a player is positioned at a distance from the board and seeks to toss bags into the opening. However, this design was not particularly portable and not well suited for modern events such as tailgating. U.S. Pat. No. 4,961,586 described a bag tossing game that includes a transportable mode, a display mode, and a playing mode. The playing mode includes a pair of slightly inclined, apertured targets towards which soft bags are thrown to generate points in accordance with rules. Further, if one wishes to use a support surface as well as play a toss game, the participant is required to transport the support surface and the game to the event locations.

An attempt to combine the support surface with the game is disclosed in U.S. Pat. No. 8,127,689 which is a system that is composed of two separate assemblies, each including a surface cover cap which can be removed to create an aperture dimensioned to allow a projectile to pass entirely through it as well as can be configured as freestanding tables. The disadvantage with this attempt is that its use requires an area (e.g., footprint) that is at least as large as the assemblies themselves. At events where tailgating occurs, the amount of square footage that is available to the participant can be severely limited and, acquiring additional space for a tailgating event is either not available or cost prohibitive, especially if the space needs to be adjoining.

It would be advantageous to have a system that can provide a support surface as well as a game platform in combination.

It would be advantageous that such a system minimizes the area needed such as overlapping the area already occupied by a vehicle.

It would be advantageous if the system is portable.

It would be advantageous if the system can be used for tailgating without the needs for an actual tailgate.

### BRIEF SUMMARY OF THE INVENTION

The above objectives are accomplished by providing a portable convertible platform assembly comprising of: a first configuration having a horizontal support surface including a first and a second section in a locked position; a second configuration wherein the sections are placed in a folded arrangement; and a third configuration wherein the support surface has an opening for receiving a game piece such as a bag filled with beads, balls, kernels, beans, and the like. The first configuration can include a securing strap such as a rear support strap for securing the platform to the hood of a vehicle, a rear leg, and a front leg. The front leg can include an adjustable height. The third configuration can include an opening cover configured to be received in the opening.

The portable support and game surface can include a platform having a first panel and second panel hingeably connected; a rear support configured to support the platform on a hood of a vehicle; a front support having an adjustable length and configured to support the platform on a hood of a vehicle wherein the platform is horizontal relative to the ground when supported by the hood and angled relative to the ground when supported by the ground; securing straps attached to the platform and removeable attached to a distal edge of the hood configured to secure the platform to the hood; an opening defined in the platform for receiving a game piece; and, an opening cover configured to be received in the opening when the platform is supported by the hood. A friction surface can be included in the rear support. The opening can be defined by a first semi-circle in the first panel and a second semi-circle in the second panel. The platform can include a storage configuration wherein the first panel is disposed on top of the second panel and wherein a third panel, having the opening, and can be disposed between the first panel and the second panel in an operational position.

The platform can include a storage configuration wherein the first panel, the second panel and the third panel are in a stacked arrangement. A locking assembly can be included and configured to lock the first panel and the second panel in an operational configuration. A level can be included and configured to assist with adjustment of the front support to provide a platform parallel with the ground. A lateral strap can be included and configured to prevent the platform from sliding across the hood. The platform can include a display area and a pouch that can be secured to the platform including the underside of the first panel.

A resilient member can be included in the rear support. The game piece can be a bag filled with kernels. The front support can be a telescoping front support. The locking assembly can include a first bar configured to secure the first and third panel in an operational configuration and a second bar configured to secure the second and third panel of the operational configuration. The opening is defined in a center panel. A strap assembly can be attached to the platform and include a first strap and a second strap wherein the first strap is configured to be received into the second strap in a storage configuration.

The portable support and game surface can include a platform having a first panel, a second panel and a third panel; wherein the third panel is disposed horizontally between the first panel and the second panel in an operational configuration; a rear support attached to the first panel; a front support attached to the first panel having an adjustable length and configured to support the platform on a hood of a vehicle wherein the platform is horizontal relative to the ground when supported by the hood and angled relative to the ground when supported by the ground. An opening defined in the third panel, and an opening cover configured to be received in the opening when the platform is in the operational configuration.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a perspective view of aspects of the system.

FIG. 2 is a perspective view of aspects of the system.

FIG. 3 is a top-down view of aspects of the system.

FIG. 4 is a perspective view of aspects of the system.

FIG. 5 is a perspective view of aspects of the system.

FIG. 6 is a perspective view of aspects of the system.

### DETAILED DESCRIPTION OF THE INVENTION

With reference to the drawings, the invention will now be described in more detail.

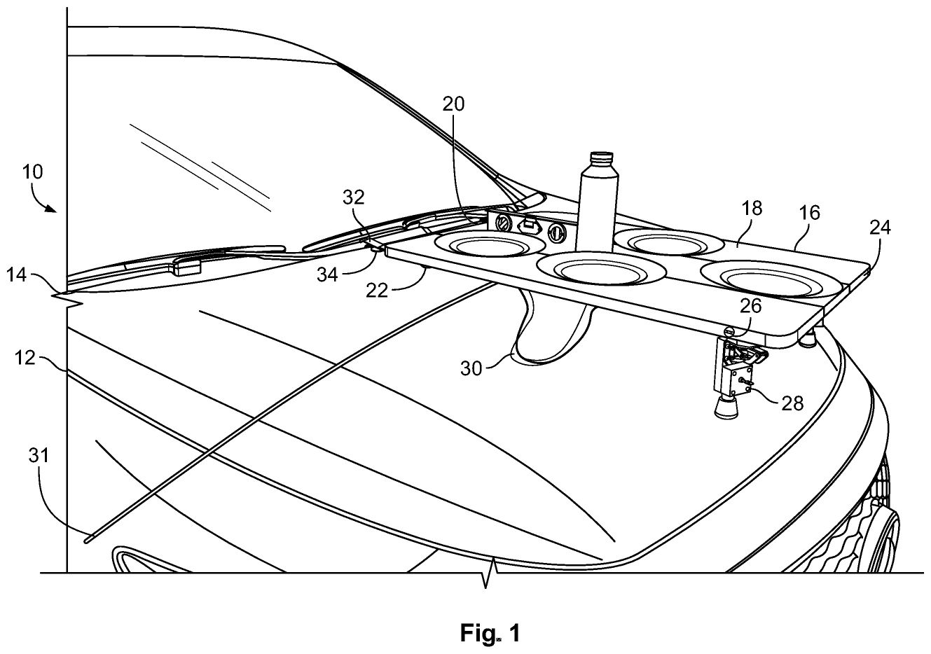

Referring to FIG. 1, a vehicle shown generally at 10 includes a hood 12 that includes a hood proximal edge 14 that can be adjacent to the windshield. A platform 16 can be disposed on or supported by the hood of the vehicle and include a support surface 18 for supporting articles. A rear end 20 can be generally disposed adjacent to the hood proximal edge and supported by one or more rear supports 22. The rear support can extend from the underside of the platform and can include a friction surface on the supports to restrict sliding on the hood. The rear support can include a resilient member that can provide shock absorption when articles are placed on the platform and reduce or prevent damage to the hood of the vehicle.

The rear supports can also be attached to the rear end of the platform and can be integrated into the rear end of the platform. In one embodiment, the rear end can include a non-friction pad, area or strip that can contact the hood of the vehicle. In an operational configuration, the platform and its panels or sections are disposed adjacent to each other along a horizontal plane to provide for the support surface, when supported by a hood, and a game surface when supported by the ground.

The front end 24 can be configured to be rearward of the distal end of the hood, even with the hood or extend past the distal end of the hood. In the configuration where the platform is rearward or even with the hood, the platform and its support surface do not require additional area beyond the area taken by the vehicle thereby conserving space. The front end can have one or more front supports 26. The front supports can be longer than the rear supports so that the support surface is horizontally flat relative to the ground, gravity, and have even altitude as well as any combination regardless of any incline that the hood may have. The front supports can include a non-friction surface 28 to resist or prevent the platform from sliding along the vehicle. The front supports can include a spring in a telescoping configuration so that shock absorption functionality is provided by the front support.

A level indicator 26 can be included in the platform to assist the user in adjusting the rear and front supports to level the support surface. The length of the rear and front supports can be extended including having a telescopic, rotational, hinged, slidable, or otherwise adjustable, configuration. Carry strap 30 can be attached to the platform to improve transportation of the platform. The rear and front supports can be rotatably attached to the platform so that they can be folded onto the platform for transportation and storage of the platform. An adjustable securing strap such as a rear support strap 32 can be attached to the platform and include a fastener 34 that can secure the rear support strap to the vehicle to reduce or prevent the platform from sliding forward. The fastener can include a curved portion such as a hook to engage with the proximal edge of the hood to assist with preventing the platform from sliding toward the front of the hood.

A lateral securing strap 31 can be attached to a side of a panel at one end and removeable attached to a side of the vehicle at the other end. The end secured to the vehicle can be secured to the wheel well, bumper, frame or other part of the car and configured to reduce or prevent motion of the platform across the hood.

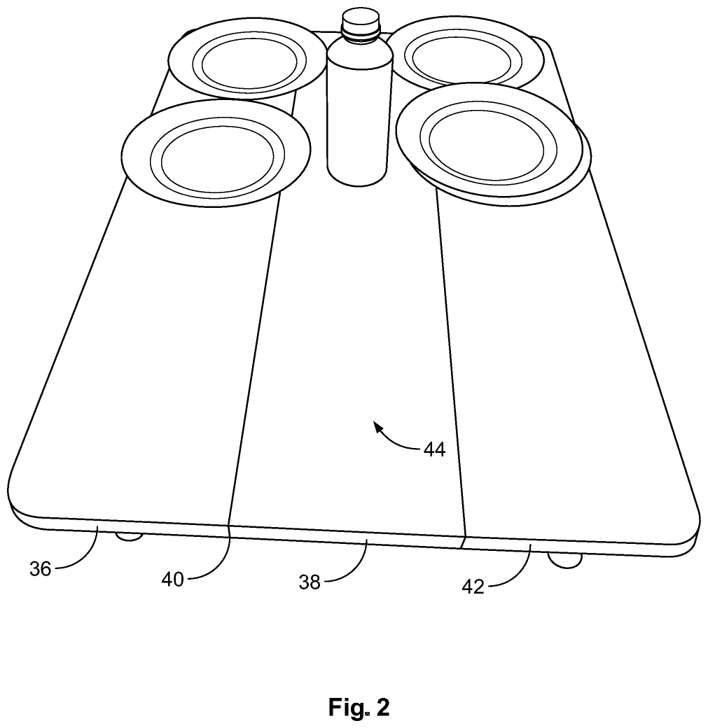

Referring to FIG. 2, the platform can include a section that can be folded relative to each other. A first section 36 can be attached to a second section 38 so that they can rotate relative to each other along a plane 40. The two sections can be rotatable when attached so that when unfolded they provide the support surface. The platform can have a third section 42. Including sections into the platform allows the platform to be folded into a footprint that can be stored in the truck, backseat, or other storage area of the vehicle. The platform can include two or more platforms that when folded are stacked in a storage or are arranged in a stacked configuration.

The platform can include a display area 44 that can be disposed on one section or extend to more than one section. The display area can be used for displaying a team, mascot, hobby, or other indicator.

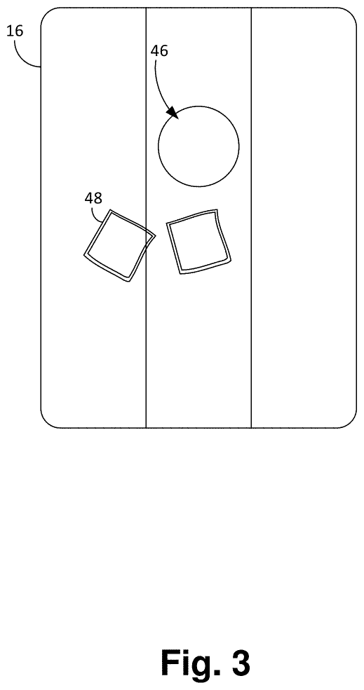

Referring to FIG. 3, the platform can include an opening 46 configured to receive a bag 48 or other items that can be tossed from a distance to the platform. The opening can be defined by:

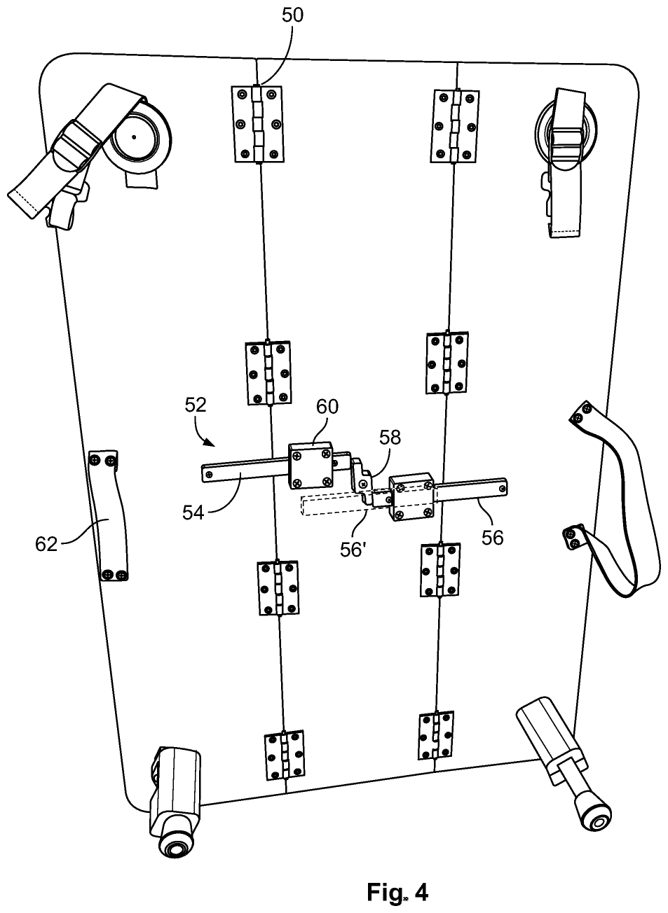

Referring to FIG. 4, the underside of the platform can be seen. The sections can be attached to each other using one or more hinges 50. When the sections are extended to form the support surface, the section can be held in place by a locking assembly 52. The locking assembly can include a first bar 54 and a second bar 56. The first and second bar can be slidable relative to the sections and have a lock and unlock position. In the lock positions, the bars can extend between sections and restrict the sections from rotating from an aligned position. In the aligned position the sections can form the support surface or a game playing surface. The unlocked position 56′ allows the bars to be disposed within the boundary of the corresponding section, the center section in one embodiment. A bar lock 58 can have a locked and unlocked position so that in the locked position, the bars are restricted from moving out of the locked position. In one embodiment, the bar lock can rotate relative to the bars. The bars can be received into a bar block 60 so that the bars slide within the bar block between the locked and unlocked positions.

The carry strap can include a first carry strap 30 and a second carry strap 62. The second carry strap can receive the first carry strap so that the platform can be carried in a folded position using the first carry strap.

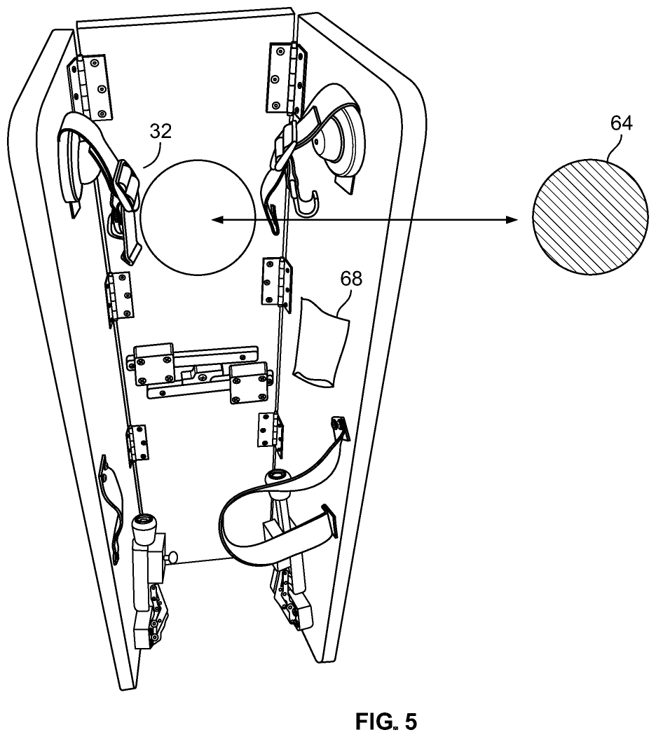

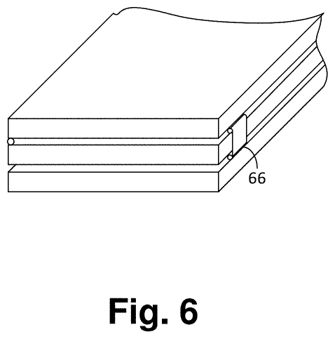

Referring to FIG. 5, the platform is shown in a folded position. The supports can be rotated relative to the center section and the front supports folded against the underside of one or more of the sections. In one embodiment, the sections can be configured to be folded so that each section is positioned adjacent to the adjoining section. The adjustable rear support strap 32 can be disposed adjacent the respective section for transportation and storage. The locking assembly is shown in the unlocked position. The opening can receive an opening cover 64 that can be removed when the platform is serving as a game platform and inserted into the opening when the platform is being used for a support surface. The opening cover can be slidable or rotatably connected to the platform. In one embodiment, a hinge 66 (FIG. 6) can be attached between two sections and configured to allow a middle section to be attached to a first end section and a second end section so that the sections can be folded with the middle section on top, the first end section below and the second end section below the first end section. This allows the panels to be stacked when in a storage configuration. A pouch 68 can be attached to the platform for holding articles such as toss bags, game pieces, condiments, utensils, sporting equipment and the like.

It is understood that the above descriptions and illustrations are intended to be illustrative and not restrictive. It is to be understood that changes and variations may be made without departing from the spirit or scope of the following claims. Other embodiments as well as many applications, besides the examples provided, will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect or subject matter that is disclosed herein is not a disclaimer of such subject matter, nor should it be regarded that the inventor did not consider such subject matter to be part of the disclosed inventive subject matter.

What is claimed is:

1. A portable support and game surface comprising of:
a platform having a first panel and second panel hingeably connected;
a rear support configured to support the platform on a hood of a vehicle;
a front support having an adjustable length and configured to support the platform on the hood of the vehicle wherein the platform is horizontal relative to the ground when supported by the hood and angled relative to the ground when supported by the ground;
securing straps attached to the platform and removeable attached to a distal edge of the hood configured to secure the platform to the hood;
an opening defined in the platform for receiving a game piece; and,
an opening cover configured to be received in the opening when the platform is supported by the hood.

2. The portable support and game surface of claim 1 including a friction surface included in the rear support.

3. The portable support and game surface of claim 1 wherein the opening is defined by a first semi-circle in the first panel and a second semi-circle in the second panel.

4. The portable support and game surface of claim 1 including a storage configuration wherein the first panel is disposed on top of the second panel.

5. The portable support and game surface of claim 1 including a third panel wherein the opening is defined in the third panel and the third panel is disposed between the first panel and the second panel in an operational position.

6. The portable support and game surface of claim 1 including a storage configuration wherein the first panel, the second panel, and a third panel are in a stacked arrangement.

7. The portable support and game surface of claim 1 including a locking assembly configured to lock the first panel and the second panel in an operational configuration.

8. The portable support and game surface of claim 1 including a level configured to assist with positioning the platform parallel relative to the ground.

9. The portable support and game surface of claim 1 including a lateral strap configured to prevent the platform from sliding across the hood.

10. The portable support and game surface of claim 1 including a display area.

11. The portable support and game surface of claim 1 including a pouch secured to an underside of the first panel.

12. A portable support and game surface comprising of:
a platform having a first panel and second panel hingeably connected;
a rear support configured to support the platform on a hood of a vehicle;
a front support having an adjustable length and configured to support the platform on the hood of the vehicle wherein the platform is horizontal relative to the ground when supported by the hood and angled relative to the ground when supported by the ground;
an opening defined in the platform for receiving a game piece; and,
an opening cover configured to be received in the opening when the platform is supported by the hood.

13. The portable support and game surface of claim 12 including a resilient member included in the rear support.

14. The portable support and game surface of claim 12 wherein the game piece is a bag filled with kernels.

15. The portable support and game surface of claim 12 wherein the front support is a telescoping front support.

16. The portable support and game surface of claim 12 including a third panel and a locking assembly wherein the locking assembly includes a first bar configured to secure the first panel and a third panel in an operational configuration, and a second bar configured to secure the second and third panel in the operational configuration.

17. The portable support and game surface of claim 16 wherein the opening is defined in a center panel.

18. The portable support and game surface of claim 12 include a strap assembly having a first strap and a second strap wherein the first strap is configured to be received into the second strap in a storage configuration.

19. A portable support and game surface comprising of:
a platform having a first panel, a second panel, and a third panel;
wherein the third panel is disposed horizontally between the first panel and the second panel in an operational configuration;
a rear support attached to the first panel;
a front support attached to the first panel having an adjustable length and configured to support the platform on a hood of a vehicle wherein the platform is horizontal relative to the ground when supported by the hood and angled relative to the ground when supported by the ground;
an opening defined in the third panel, and,
an opening cover configured to be received in the opening when the platform is in the operational configuration.

20. The portable support and game surface of claim 1 including a rear securing strap configured to secure the platform to the hood of the vehicle and a lateral strap configured to secure the platform to the hood of the vehicle.
